(19) United States
(12) Patent Application Publication
(10) Pub. No.: US 2015/0341280 A1
(43) Pub. Date: Nov. 26, 2015

(54) METHOD TO DIFFUSE CLOUD PEAK LOAD BY DYNAMICALLY ADJUSTING COMMUNICATION SCHEDULES

(71) Applicants: Toshiba Tec Kabushiki Kaisha, Tokyo (JP); Kabushiki Kaisha Toshiba, Tokyo (JP)

(72) Inventors: Jianxin Wang, Trabuco Canyon, CA (US); Michael Yeung, Mission Viejo, CA (US); William Su, Shenzhen (CN)

(21) Appl. No.: 14/285,323

(22) Filed: May 22, 2014

(51) Int. Cl. H04L 12/875; H04L 29/06

(52) U.S. Cl. CPC H04L 47/56; H04L 67/42

(57) ABSTRACT

Systems, methods, and servers for providing services to a device are described. A device connected to a network is configured to transmit, via the network, a request for a service in accordance with a first communications schedule. The device may receive, via the network, a modified communications schedule. The device may re-transmit, via the network, the request for the service in accordance with the modified communications schedule.

### BACKGROUND

1. Field

This disclosure relates to user interfaces for mobile devices used in conjunction with multifunction peripherals.

2. Description of the Related Art

A multifunction peripheral (MFP) is a type of document processing device which is an integrated device providing at least two document processing functions, such as print, copy, scan and fax. In a document processing function, an input document (electronic or physical) is used to automatically produce a new output document (electronic or physical).

Documents may be physically or logically divided into pages. A physical document is paper or other physical media bearing information which is readable unaided by the typical human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as documents, unless the context requires some discussion of physical documents which will be referred to by that name specifically.

In printing, the MFP automatically produces a physical document from an electronic document. In copying, the MFP automatically produces a physical document from a physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organization's networks which also include various other workstations, servers and peripherals. An MFP may provide remote document processing services to external or network devices.

An MFP may also receive services from the “cloud”, which is to say from one or more remote computing devices accessed via a network. Services received from the cloud may include, for example, maintenance services such as monitoring of the MFP operational status, monitoring the amount of consumables (e.g. paper and toner) available at the MFP, and providing configuration and software/firmware updates. Services received from the cloud may also include may also include management services such as aggregating useable and billing information across multiple MFPs and security services such as distribution and validation of user credentials (e.g. user identities and passwords). In some cases, such as reporting maintenance and billing information, the “service” provided by the cloud may be simply to accept, store, and aggregate information pushed up to the cloud by one or more document processing devices. Services received from the cloud may further include document services such as character recognition processing of scanned documents and remote document storage. These and other services will be generically referred to as “services” in this document.

### DESCRIPTION OF THE DRAWINGS

FIG. 1 is a diagram of a system.

FIG. 2 is a block diagram of a MFP.

FIG. 3 is a block diagram of a computing device.

FIG. 4 is a block diagram of software for a MFP with access to services.

FIG. 5 is a flowchart of process for accessing services.

Throughout this description, elements appearing in figures are assigned three-digit reference designators, where the most significant digit is the figure number where the element is introduced, and the two least significant digits are specific to the element. An element that is not described in conjunction with a figure may be presumed to have the same characteristics and function as a previously-described element having the same reference designator.

### DETAILED DESCRIPTION

Description of Apparatus

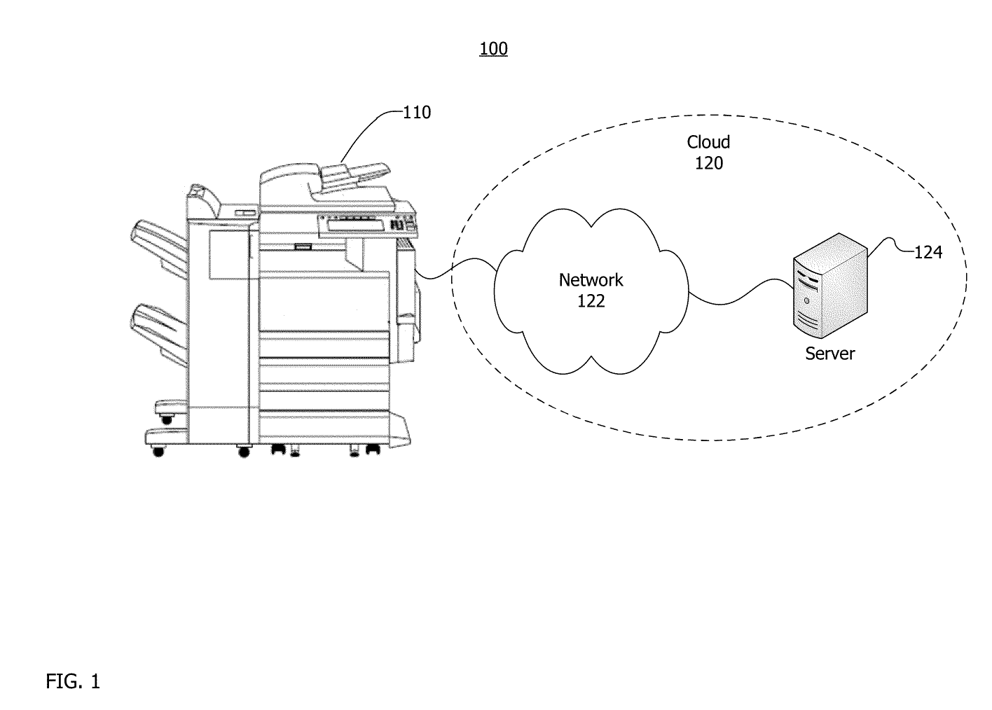

Referring now to FIG. 1, a system 100 may include a document processing device 110 and a cloud 120. The cloud 120 may include a network 122 and at least one real or virtual server 124. A system may include more than one document processing device and more than one server.

The document processing device 110 may be configured to provide one or more document processing operations such as printing, copying, scanning and faxing. The document processing device may be, as shown, a MFP capable of performing two or more document processing operations.

The network 122 may be or include a local area network, a wide area network, a personal area network, a mobile or telephone network, the Internet, an intranet, or any combination of these. The network 122 may have physical layers and transport layers according to IEEE 802.11, Ethernet or other wireless or wire-based communication standards and protocols such as WiMax®, Bluetooth®, mobile telephone and data protocols, the public switched telephone network, a proprietary communications network, infrared, and optical.

The server 124 may be configured to provide services to document processing devices, such as the document processing device 110, via the network 122. The server 124 may be implemented by software operating on a server computer connected to the network 122.

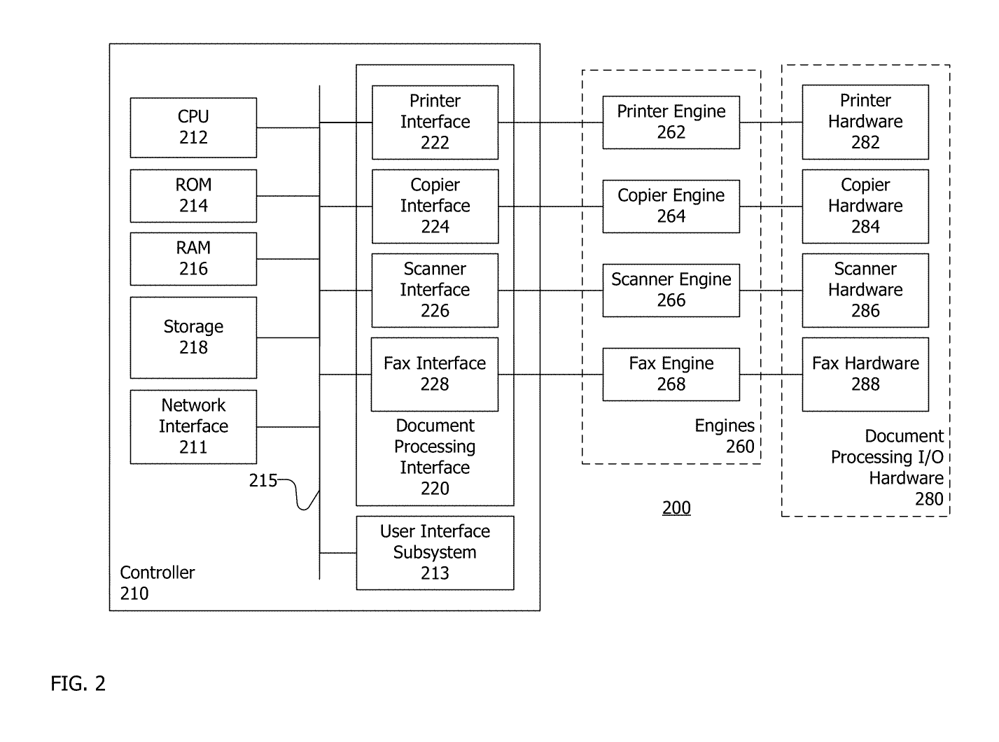

FIG. 2 is a block diagram of an MFP 200 which may be the document processing device 110. The MFP 200 includes a controller 210, engines 260 and document processing I/O hardware 280. The controller 210 includes a CPU 212, a ROM 214, a RAM 216, a storage 218, a network interface 211, a bus 215, a user interface subsystem 213 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 218 provides volatile, bulk or long term storage of data associated with the MFP 200, and may be or include disk, optical, tape or solid state. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 122 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from and provide output to the user interface subsystem 213.

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions.

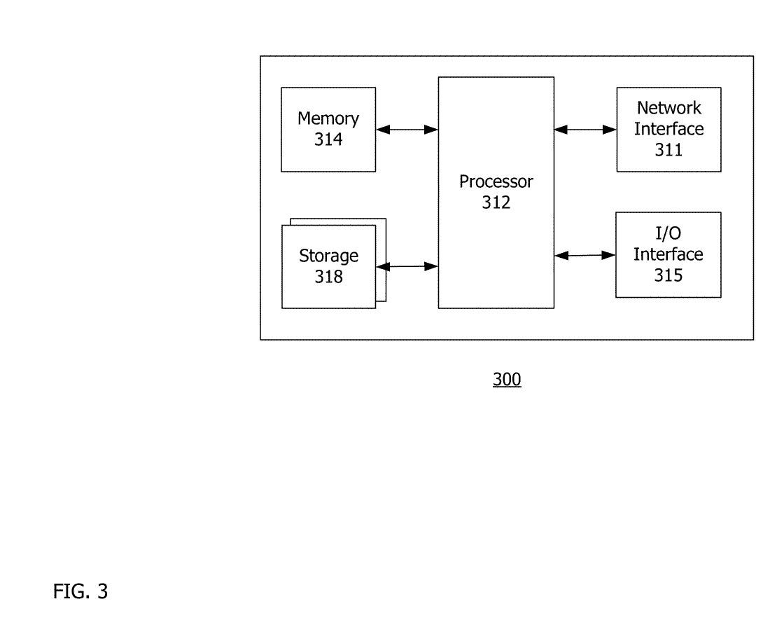

Turning now to FIG. 3, a computing device 300 may be representative of the server computers, client devices, mobile devices and other computing devices discussed herein. The controller 210 of FIG. 2 may also incorporate, in whole or in part, a general purpose computer like the computing device 300. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 may have a processor 312 coupled to a memory 314, storage 318, a network interface 311 and an I/O interface 315. The processor may be or include one or more microprocessors and application specific integrated circuits (ASICs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 may provide non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

The network interface 311 may be configured to interface to a network such as network 122 (FIG. 1).

The I/O interface 315 may be configured to interface the processor 312 to peripherals (not shown) such as displays, keyboards and USB devices.

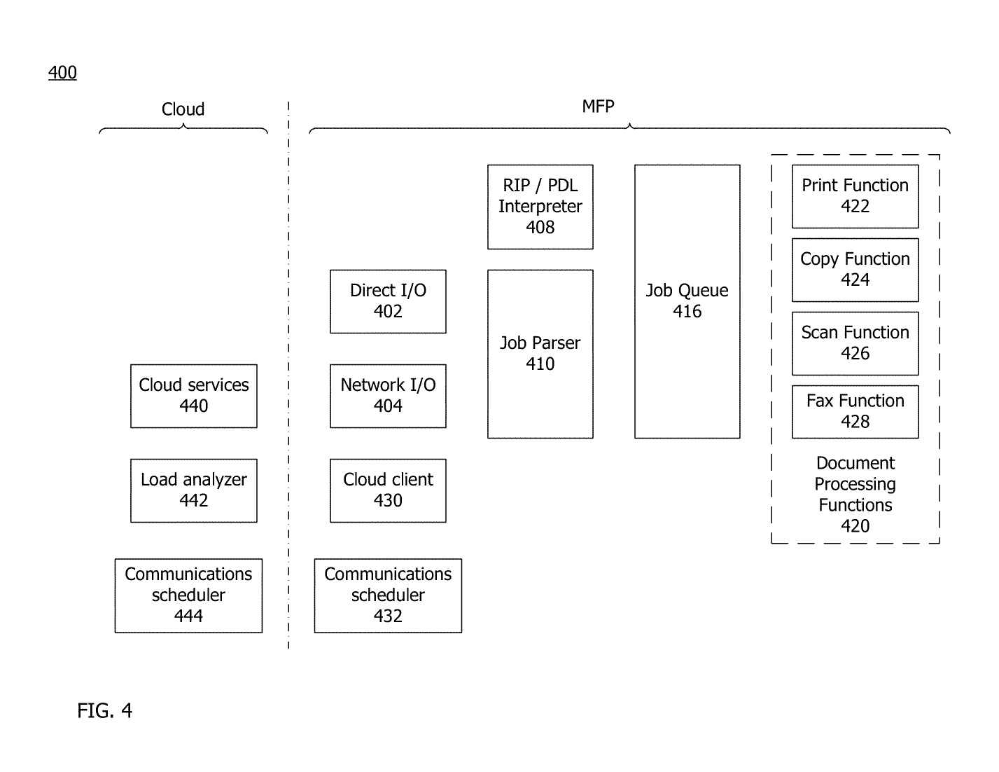

FIG. 4 is a block diagram of a software system 400 of an MFP, which may be the document processing device 110 and a service cloud, which may be the cloud 120. A portion of the software system 400 within the MFP may be replicated within a plurality of MFPs connected to a common service cloud. A portion of the software system 400 within the service cloud may be unique and shared by plurality of MFPs.

The portion of the software system 400 within the MFP may operate, for example, on the controller 210 of the MFP 200. The portion of the software system 400 within the MFP may include client direct I/O 402, client network I/O 404, a RIP/PDL interpreter 408, a job parser 410, a job queue 416, a series of document processing functions 420 including a print function 422, a copy function 424, a scan function 426 and a fax function 428.

The client direct I/O 402 and the client network I/O 404 may provide input and output to the MFP controller. The client direct I/O 402 is for the user interface on the MFP, and the client network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP (hypertext transfer protocol), FTP (file transfer protocol), UDP (user datagram protocol), TCP (transmission control protocol), electronic mail, TELNET or other network communication protocols.

The RIP/PDL (Raster Image Processor/Page Description Language) interpreter 408 may transform PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the client network I/O 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the client direct I/O 402. The client direct I/O 402 may include printing, fax transmission or other input of a document for handling by the software system 400.

The print function 422 enables the MFP to print documents and implements each of the various functions related to that process. These include stapling, collating, hole punching, and similar functions. The copy function 424 enables the MFP to perform copy operations and all related functions such as multiple copies, collating, 2 to 1 page copying or 1 to 2 page copying and similar functions. Similarly, the scan function 426 enables the MFP to scan and to perform all related functions such as shrinking scanned documents, storing the documents on a network or emailing those documents to an email address. The fax function 428 enables the MFP to perform facsimile operations and all related functions such as multiple number fax or auto-redial or network-enabled facsimile.

Some or all of the document processing functions 420 may be implemented on a client computer, such as a personal computer or thin client. The user interface for some or all document processing functions may be provided locally by the MFP's user interface subsystem though the document processing function is executed by a computing device separate from but associated with the MFP.

The portion of the software system 400 may include an MFP cloud client 430 that requests services, as previously defined, from a service cloud. Services relating to a specific document processing task, such as OCR processing of a document scanned by the MFP, may be requested on an as-needed basis. Routine services, such as reporting MFP status and consumables usage, may be performed periodically as defined by an MFP communications scheduler 432 within the MFP. The MFP communications scheduler 432 may schedule requests for various services nightly, weekly, monthly, or on some other schedule. Different services may be scheduled at different intervals.

Requests for service generated by the MFP cloud client 430 may be fulfilled by cloud services applications 440 running on one or more computing devices within a cloud, such as the server 124 within the cloud 120. The cloud may include a load analyzer 442 to determine, upon receipt of a request for service from the MFP, whether or not resources are available to fulfill the request. Resources required to fulfill a request may include, for example, a communications bandwidth and a processor capacity. When resources are not instantly available to fulfill a request, the load analyzer may analyze a temporal load distribution for the resources to identify a future time when resources will be available. A cloud communications scheduler 444 may then negotiate a modified communications schedule with the MFP communications scheduler 432 to cause the MFP cloud client 430 to retransmit the request for service at the identified future time. The cloud communications scheduler 444 may negotiate communications schedules with the respective MFP communications schedulers 432 of a plurality of MFPs. As will be discussed, the cloud communications scheduler 444 and the MFP communications scheduler 432 may collaboratively execute a process to balance the communications and processing load on the service cloud.

Description of Processes

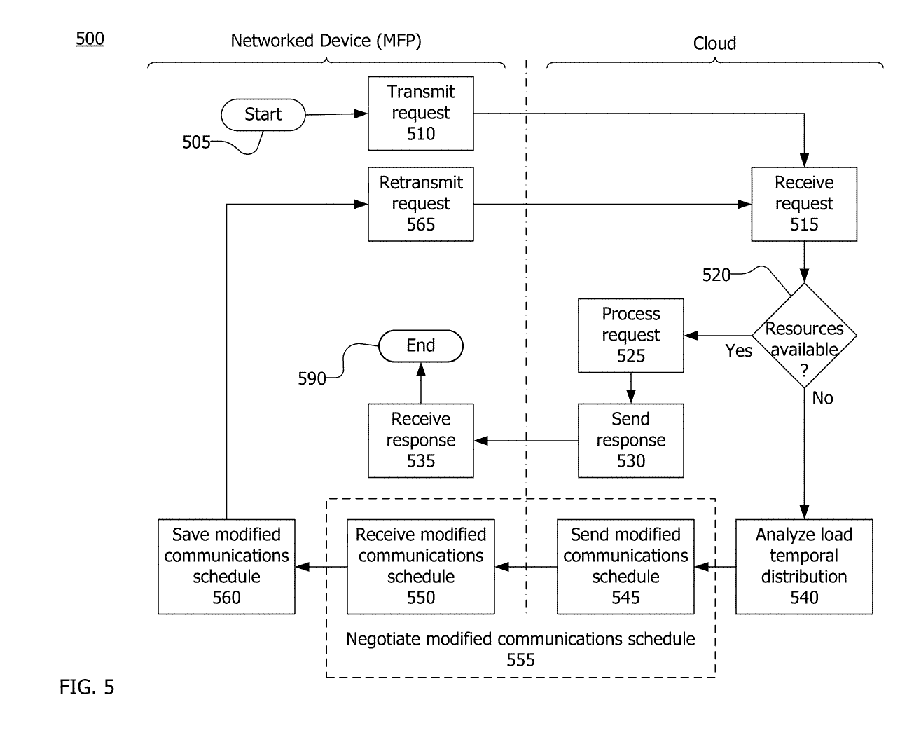

FIG. 5 shows a flowchart of a process 500 for accessing services from a cloud. The process 500 may be performed by a networked device in conjunction with a cloud including a communications network and at least one server. The networked device may be, for example, a MFP or other document processing device, or some other device that request non-time-critical services. The process 500 starts at 505 and ends at 590. The process 500 may be initiated by the networked device in accordance with a first schedule. The first schedule may cause the device to initiate the process 500 periodically, such as hourly, nightly, weekly, monthly, or on some other periodic schedule. The first schedule may cause the device to initiate the process 500 at predetermined times or time intervals on as-needed basis. Multiple instances of the process 500 may run concurrently on a networked device to request different services on different schedules. Many instances of the process 500 may run concurrently in the cloud to provide services to a corresponding number of networked devices. The process 500 may repeat or recur any number of times.

At 510, a networked device may transmit a request for service to the cloud, which is to say send a request for service via a network to a remote server. The request for service may be received by a server within the cloud at 515. Upon, or shortly after, receiving the request for service, the server may determine at 520 whether or not resources are presently available to fulfill the request for service. Resources required to fulfill a request for service may include, for example, some amount of communications bandwidth over the network and/or some amount of processing capacity.

When resources are available to fulfill the request for service (“yes” at 520), the request for service may be processed at 525 and a response may be sent by the server at 530 and received by the networked device at 535. Depending on the type of service requested, additional messages and/or data may be exchanged between the networked device and the server (not shown in FIG. 5). When the request for service has been fulfilled, the process 500 may end at 590.

When resources to fulfill the request for service are not available (“no” at 520), the temporal load distribution of the resources needed to fulfill the request for service may be analyzed at 540 to identify a future time when resources to fulfill the request are expected to be available. This analysis may consider other requests for services that are currently being processed, requests for services that have been received, and requests for services that are anticipated but not yet received by the cloud. After a future time when resources to fulfill the request for service will be available has been indentified at 540, a modified communication schedule may be sent to the networked device at 545.

The modified communications schedule transmitted at 545 may define a future time for retransmission of the request for service such that the retransmitted request arrives at the cloud at a time when the resources needed to fulfill the request for service are expected to be available. The modified communications schedule may define a future time for retransmission of a single request for service. For example, the modified communications schedule may instruct the networked device to retransmit the request for service after a defined delay (e.g. “in 17 minutes”) or at defined time (e.g. “at 2:35 AM”). The modified communications schedule may define a future time for retransmission of all future requests for a particular service. For example, the first communications schedule may cause the networked device to request the same service at midnight every night, and the modified communications schedule may instruct the networked device to request that service at 1:17 every morning.

The modified communications schedule may be received by the networked device at 550. In some situations, a modified communications schedule proposed by the server may be unacceptable to the networked device. For example, the proposed modified communications schedule may conflict with some other activity scheduled for the networked device. In these situations, the networked device may reject the proposed modified communications schedule and a different modified communications schedule may be negotiated between the server and the networked device, as indicated by the dashed box 555. With or without negotiation, the modified communications schedule may be stored by the networked device at 560. Subsequently, the request for service may be retransmitted at 565 in accordance with the modified communications schedule.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system, comprising:
a device connected to a network, the device is configured:
to transmit, via the network, a request for a service in accordance with a first communications schedule,
to receive, via the network, a modified communications schedule, and
to re-transmit, via the network, the request for the service in accordance with the modified communications schedule.

2. The system of claim 1, wherein
the modified communications schedule defines a particular future time for retransmission of the request for the service.

3. The system of claim 1, wherein
the modified communications schedule defines a schedule for transmission of all future requests for the service.

4. The system of claim 1, wherein
the device is a multifunction peripheral.

5. The system of claim 1, further comprising:
a server connected to the network, the server configured:
to receive, via the network, the request for the service from the device;
to determine whether or not resources to fulfill the request for the service are available; and
when resources to fulfill the request for the service are not available, to transmit, via the network, the modified communications schedule to the device.

6. The system of claim 5, wherein the server is further configured:
upon determining that resources to fulfill the request for the service are not available, analyzing a temporal load distribution to identify a future time when resources will be available to fulfill the request for the service and defining the modified communications schedule such that the request for the service is retransmitted by the device at the identified future time.

7. The system of claim 6, wherein the resources to fulfill the request for service include one or both of a communications bandwidth and a processing capacity.

8. A method for a device to receive a service via a network, comprising:
a device connected to a network, the device is configured:
to transmit, via the network, a request for the service in accordance with a first communications schedule,
to receive, via the network, a modified communications schedule, and
to re-transmit, via the network, the request for the service in accordance with the modified communications schedule.

9. The method of claim 8, wherein
the modified communications schedule defines a particular future time for retransmission of the request for the first service.

10. The method of claim 8, wherein
the modified communications schedule defines a schedule for transmission of all future requests for the service.

11. The method of claim 8, wherein
the device is a multifunction peripheral.

12. The method of claim 8, further comprising:
a server receiving, via the network, the request for the service from the device;
the server determining whether or not resources to fulfill the request for the service are available; and
when resources to fulfill the request for the service are not available, to transmit, via the network, the modified communications schedule to the device.

13. The method of claim 12, wherein the server is further configured:
upon determining that resources to fulfill the request for the service are not available, analyzing a temporal load distribution to identify a future time when resources to fulfill the request for the service will be available and defining the modified communications schedule such that the request for the service is retransmitted by the device at the identified future time.

14. The method of claim 13, wherein the resources to fulfill the request for service include one or both of a communications bandwidth and a processing capacity.

15. A server, comprising:
a processor, memory, and an interface to a network, the processor executing instructions that cause the server to perform actions including:
receiving, via the network, a request for a service from a device connected to the network;
determining whether or not resources to fulfill the request for the service are available; and
when resources to fulfill the request for the service are not available, to transmit, via the network, the modified communications schedule to the device.

16. The server of claim 15, the actions performed further including:
upon determining that resources to fulfill the request for the service are not available, analyzing a temporal load distribution to identify a future time when resources to fulfill the request for the service will be available and defining the modified communications schedule such that the request for the service is retransmitted by the device at the identified future time.

17. The server of claim 15, wherein
the modified communications schedule defines a particular future time for retransmission of the request for the first service.

18. The server of claim 15, wherein
the modified communications schedule defines a schedule for transmission of all future requests for the service.

19. The server of claim 15, wherein the resources to fulfill the request for service include one or both of a communications bandwidth and a processing capacity.
